(19) United States
(12) Patent Application Publication
(10) Pub. No.: US 2020/0204619 A1
(43) Pub. Date: Jun. 25, 2020

(54) CLOUD SERVICES DISINTERMEDIATION

(71) Applicant: HEWLETT-PACKARD DEVELOPMENT COMPANY, L.P., Spring, TX (US)

(72) Inventors: Christoph J. Graham, Houston, TX (US); Thomas Joseph Flynn, Houston, TX (US); Donald Lance Stevens, Houston, TX (US)

(21) Appl. No.: 16/481,973

(22) PCT Filed: Sep. 15, 2017
(86) PCT No.: PCT/US2017/051917

§ 371 Date: Jul. 30, 2019

(51) Int. Cl. H04L 29/08; H04L 12/14

(52) U.S. Cl. CPC H04L 67/1021; H04L 67/1097; H04L 12/14; H04L 67/1074; H04L 67/322; H04L 67/1053

(57) ABSTRACT

In some examples, a computing device can include a processing resource, and a memory resource storing machine-readable instructions to cause the processing resource to monitor a characteristic of a user device. The characteristic can include the location of the user device, and communicate with a central resource to disintermediate cloud service offerings based on the characteristic of the user device.

### BACKGROUND

Cloud computing refers to the use of dynamically saleable computing resources accessible via a network, such as the Internet. The computing resources, often referred to as a “cloud,” provide services to users. These services can be categorized according to service types, which may include for examples, applications/software, platforms, infrastructures, virtualization, and servers and data storage. The names of service types are often appended to the phrase “as-a-Service” such that the delivery of applications/software and infrastructure, as examples, may be referred to as Software-as-a-Service (SaaS), Platform-as-a-Service (PaaS). and Infrastructure-as-a-Service (IaaS), respectively.

The term “cloud-based services” or, more simply, “cloud services” refers not only to services provided by a cloud, but also to a form of service provisioning in which cloud customers contract with cloud service providers for the online delivery of services provided by the cloud. Cloud service providers manage a public, private, or hybrid cloud to facilitate the online delivery of cloud services to cloud customers.

### BRIEF DESCRIPTION OF THE DRAWINGS

FIG. 1 illustrates an example of a computing device suitable with cloud services disintermediation consistent with the present disclosure.

FIG. 2 illustrates an example of a system to suitable with cloud service disintermediation consistent with the present disclosure.

FIG. 3 illustrates an example of a method of cloud service disintermediation consistent with the present disclosure.

### DETAILED DESCRIPTION

Various examples provide for cloud services disintermediation. A cloud service can have three characteristics that differentiate it from other approaches to a hosted service. First, a cloud service can be sold to a service consumer on demand (e.g., by the minute or the hour). Second, cloud service can be dynamic (e.g., a services consumer can have as much or as little of a service as they want at any given point in time). Third, which applies specifically to public clouds as opposed to private or hybrid clouds, is that the cloud service can be managed by a cloud services provider (e.g., the services consumer has a suitably equipped client device and network connection). This third functionality can be particularly relevant to public clouds. However, private clouds can be managed by an internal information technology (IT) department and/or through ITO (IT Outsourcing) contracts. I&O (Infrastructure & Operations) administrators can act as the cloud provider and, accordingly, this third functionality would be of similar relevance.

Some cloud management models may involve cloud service users and IT organization cloud service users (i.e., cloud service users) of a cloud service consumer (e.g., a business, an institution, an individual or the like) directly implementing cloud services via cloud service providers (e.g., IaaS, PaaS, SaaS, enterprise resource planning (ERP), and managed services (MS) available on an outside networks) without oversight andlor involvement of a centralized resource (e.g., IT management). However, there may be limitations and/or challenges in regard to implementing and/or managing cloud services with such cloud management models.

Accordingly, the disclosure is directed to cloud services disintermediation. Disintermediation can provide a user with direct access to services that would otherwise require a mediator. Desirably, cloud services disintermediation disclosed herein may provide a central resource which can interface with cloud services offerings. Specifically, the central resource may have the ability to provision, move, and/or deprovision services across data center boundaries of a cloud services provider. Additionally, the central resource may have the ability to migrate and leverage services across multiple cloud service providers. The central resource may migrate and leverage services across multiple cloud service providers based on changes in characteristics of a user device, such as a change in the location of the user device.

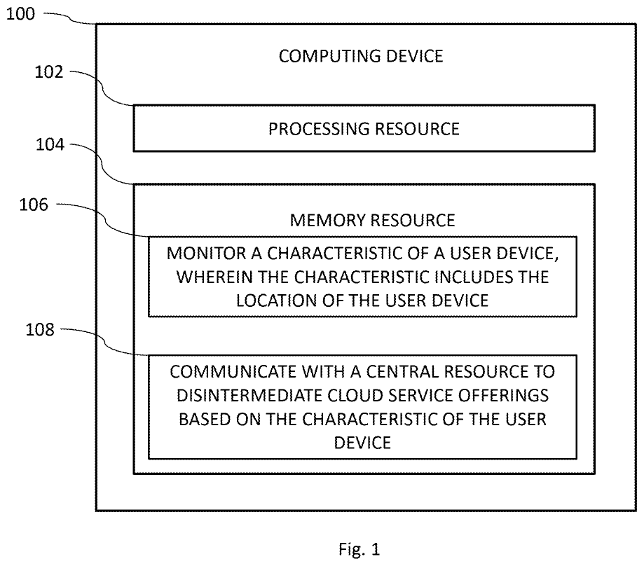

FIG. 1 illustrates an example of a computing device 100 suitable with cloud services disintermediation consistent with the present disclosure. The computing device 100 can be, for example, a laptop computer, a desktop computer, or a mobile device, among other types of computing devices. As illustrated in FIG. 1, the computing device 100 can include a processing resource 102 coupled to the memory resource 104, on which instructions may be stored, such as instructions 106 and 108. Although the following descriptions refer to an individual processing resource and an individual memory resource, the descriptions may also apply to a system with multiple processing resources and multiple memory resources. In such examples, the instructions may be distributed (e.g., stored) across multiple processing resources.

Processing resource 102 may be a central processing unit (CPU), a semiconductor based microprocessor, and/or other hardware devices suitable for retrieval and execution of instructions stored in memory resource 104. Processing resource 102 may fetch, decode, and execute instructions 106 and 108, or a combination thereof. As an alternative or in addition to retrieving and executing instructions, processing resource 102 may include an electronic circuit that includes electronic components for performing the functionality of instructions 106 and 108, or a combination thereof.

Memory resource 104 can be volatile or nonvolatile memory. Memory resource 104 can be removable (e.g., portable) memory, or non-removable (e.g., internal) memory. For example, memory resource 104 can be random access memory (RAM) (e.g., dynamic random access memory (DRAM) and/or phase change random access memory (PCRAM)), read-only memory (ROM) (e.g., electrically erasable programmable read-only memory (EEPROM) and/or compact-disk read-only memory (CD-ROM), flash memory, a laser disc, a digital versatile disk (DVD) or other optical disk storage, and/or a magnetic medium such as magnetic cassettes, tapes, or disks, among other types of memory.

Instructions 106, when executed by processing resource 102, can cause the processing resource 102 to monitor a characteristic of a user device. The user device can include a computer (e.g., desktop computer, notebook computer, tablet computer, server computer, etc.), a handheld device (e.g., personal digital assistant, smartphone, etc.), an electronic appliance, a gaming console, or any other type of user device.

The monitored characteristic can include the location of the user device. The user device can include a location detection module, which can track the location of the user device in real-time. Tracking the location of the user device in real-time can allow the centralized resource to determine which services a user should have access to. For example, the computing device 100 can detect the user device has changed locations, communicate the change in location to a central resource, and the central resource can migrate or leverage services across a plurality of cloud service providers in such a way as to minimize the disruption to the user device.

Additional characteristics of the user device which the computing device 100 can monitor can include a quality-of-service, connectivity type, user role, device role, or combinations thereof. Characteristics of the user device can depend on whether the user device is specific to a business-to-business transaction (B2B transaction) or a business-to-customer transaction (B2C transaction). Thus, rules and policies can extend to individual users of a service. For example, the central resource can determine which services a user should have access to based on a policy, such as geo-location.

Instructions 108, when executed by processing resource 102, can cause the processing resource 102 to communicate with a central resource to disintermediate cloud service offerings based on the monitored characteristic of the user device. As described herein, the central resource can include a third party company that adds value to cloud services on behalf of cloud service users.

A central resource, as described herein, offers numerous benefits over other cloud management models. The central resource can allow cloud service users to efficiently and effectively operate in current and future cloud computing environments such as to manage business demand and IT supply processes and relationships. Additionally, the central resource can serve as an aggregation point for cloud resources, cost and SLA management to design, deploy, manage and govern cloud service solutions. The centralized resource can provide a common financial model for IaaS, PaaS, and/or SaaS functionalities across various cloud configurations such as, for examples, public clouds, private clouds, and/or hybrid clouds. In a private cloud, the cloud infrastructure is self-owned such as being operated solely by an organization. However, it can be managed by the organization itself or a third-party provider and can exist on or off an organization's premise. In a public cloud, the cloud infrastructure is made available to the general public or a large industry group and is vendor-owned. A hybrid cloud is a combination of both private and public clouds, are organized so that a portion of the infrastructure is deployed in a private cloud and the rest is exposed on the public cloud.

As described herein, the central resource can also allow a rapidly changing IT service supply chain of cloud services through on-boarding of new cloud services and off-boarding retired cloud services in such a way as to minimize the disruption to end customers, while enabling them to leverage the benefits of new and better value cloud services. For example, on-boarding of new cloud services and off-boarding retired cloud services can be based on the plurality of characteristics of the user device, as monitored by the computing device.

The central resource can have easy-to-use broker capabilities for cloud services, supporting multiple customers and integrating several different providers, allowing a cloud services user to design, order, provision and control cloud services from a given portal. The central resource can facilitate a cloud service user to compare and highlight key differences and features of multiple provider offerings, such as security, service level agreements and cost, to determine the best-fit for their specifications.

The central resource can offer a central point for a cloud service user to aggregate cloud solutions, procure and pay for them by combining cloud services from different providers to meet user device's specifications, cost constraints and innovation requirements. For example, the central resource can reduce cloud costs by comparing cloud service combinations for any given solution; performing real-time spend analysis across providers; optimizing as provisioning and deprovisioning systems are integrated with billing end ordering management; and reducing time and cost in billing, metering and payment management through a centralized bill and payment capability.

As described herein, the central resource can disintermediate cloud service offerings based on the monitored characteristic of the user device. For example, the central resource can determine a plurality of cloud service the user device has access to based on the monitored characteristic of the user device, such as the location, quality-of-service, connectivity type, user role, device role, or combinations thereof of the user device.

Disintermediating cloud services can include managing resources across a plurality of cloud service providers and communicating across a plurality of cloud data centers. For example, the central resource can scale cloud service offerings. The central resource can instantiate new cloud service offerings. For example, the present disclosure can be designed to support both the instantiation of new service offerings or scaling service offerings based on users and usage requirements of the user or the business. This includes the ability to dynamically migrate services from data center to data center and/or from service provider to service provider based on the plurality of characteristics of the user device or based on changes in the plurality of characteristics of the user device.

As described herein, the present disclosure can provide a central resource that can interface with cloud service offerings. For example, the central resource can provision, move, and deprovision services across data center boundaries of a cloud service provider. Additionally, the central resource can migrate and leverage resources across a plurality of cloud service providers. The central resource can directly interface with management application program interfaces (APIs) and servicing protocols of each of the plurality of cloud service providers supported, provisioning resources on behalf of user devices.

Additionally, the present disclosure can interconnect resources across a plurality of cloud providers and data centers on behalf of a user device, creating virtual network topography for sharing resources and communicating privately across a plurality of data centers.

As described herein, the computing device 100 can detect a change in the monitored characteristic of the user device. The computing device can communicate with the central resource to disintermediate cloud service offerings based on the detected change of the monitored characteristic of the user device. For example, the central resource can instantiate new cloud services as a result of the computing device 100 alerting the central resource that there has been a change in the monitored characteristic of the user device, such as the device role, quality-of-service, connectivity type, and/or user role.

As described herein, the central resource can control provisioning of an application environment on behalf of a user or user device, and deprovisioning the application environment when there is a change in the monitored characteristic of the user device. Additionally, the central resource can consolidate ordering and billing of cloud services across a plurality of cloud services, creating a frictionless path to cloud services.

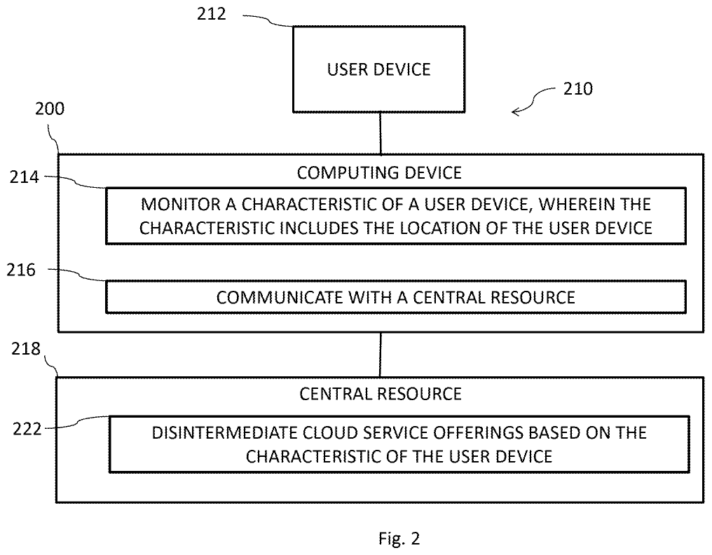

FIG. 2 illustrates an example system 210 suitable with cloud service disintermediation consistent with the present disclosure. The system 210 may include a user device 212, a computing device 200, a central resource 218, or combinations thereof.

At 214, the computing device 200 can monitor a characteristic of the user device 212. The computing device 200 can be, for example, a laptop computer, a desktop computer, or a mobile phone, among other types of computing devices.

As described herein, the user device 212 can include a computer (e.g., desktop computer, notebook computer, tablet computer, server computer, etc.), a handheld device (e.g., personal digital assistant, smartphone, etc.), an electronic appliance, a gaming console, or any other type of user device.

As described herein, the monitored characteristic can include the location of the user device 212. The user device 212 can include a location detection module, which can track the location of the user device 212 in real-time. Tracking the location of the user device 212 in real-time can allow the central resource 218 to determine which cloud services a user device 212 should have access to. For example, the computing device 200 can detect the user device 212 has changed locations, communicate the change in location to the central resource 218, and the central resource 218 can migrate or leverage services across a plurality of cloud service providers in such a way as to minimize the disruption to the user device 212.

Additional characteristics of the user device 212 which the computing device 200 can monitor can include a quality-of-service, connectivity type, user role, device role, or combinations thereof. Characteristics of the user device 212 can depend on whether the user device 212 is specific to a business-to-business transaction (B2B transaction) or a business-to-customer transaction (B2C transaction). Thus, rules and policies can extend to individual users of a service For example, the central resource 218 can determine which services an individual user should have access to based on a policy, such as geo-location.

At 216, the computing device 200 can communicate with the central resource 218. For example, the computing device 200 can communicate the status of the monitored characteristic of the user device 212 with the central resource 218. Based on the status of the monitored characteristic of the user device 212 the central resource 218 can determine a plurality of cloud services the user device 212 has access to. The plurality of cloud services can come from a plurality of cloud service providers or from an individual cloud service provider.

At 222, the central resource 218 can disintermediate cloud service offerings based on the monitored characteristic of the user device 212. For example, the central resource 218 can manage resources across a plurality of cloud service providers and/or communicate across a plurality of cloud data centers. A central resource can include instructions and hardware to disintermediate cloud services. For example, the user device 212 can be using the central resource 218 such as a virtual hosted desktop containing application and files within a cloud service provider. This service is can be hosted within a facility that is in close proximity to the user device 212. However, if the user device 212 changes location, such as to a different region, the virtualized desktop solution can be migrated to another hosting data center within the cloud service provider. The virtualized desktop solution can also be migrated to a different cloud service provider in order to provide a better quality of service, reduced latency, or reduced costs.

Disintermediating cloud service offerings based on the monitored characteristic of the user device 212 has several benefits over other approaches to related cloud services. For example, a central resource 218 that is interconnected to a computing device 200 which monitors characteristics of the user device 212 can facilitate the migration and management of services across multiple data centers, providing a better quality of service across multiple geographies that traditional cloud service. Based on characteristics of the user device 212, the central resource 218 can provide a plurality of cloud services from a plurality of cloud service providers. As described herein, the central resource 218 can consolidate ordering and billing of cloud services across a plurality of cloud services, creating a frictionless path to cloud services.

As described herein, the central resource 218 can facilitate a changing IT service supply chain of cloud services through on-boarding of new cloud services and off-boarding retired cloud services in such a way as to minimize the disruption to the user device 212, while enabling them to leverage the benefits of new and better value cloud services.

As described herein, the central resource 218 can provide easy-to-use broker capabilities for cloud services, supporting multiple customers and integrating several different providers, allowing a cloud services user to design, order, and/or provision control cloud services from a given portal. The central resource 218 can allow a cloud service user to compare and highlight key differences and features of multiple provider offerings, such as security, service level agreements and cost, to determine the best-fit for their specification. The specifications of the user device 212 can be determined by a plurality of characteristics of the user device 212 or detected changes in the plurality of characteristics of the user device 212.

The, central resource 218 can offer a central point for a cloud service consumer to aggregate cloud solutions, procure and pay for them by combining cloud services from different providers to meet user device's specifications and/or cost constraints. For example, the central resource 218 can reduce cloud costs by comparing cloud service combinations for any given solution; performing real-time spend analysis across providers; optimizing as provisioning and deprovisioning systems are integrated with billing and ordering management and reducing time and cost in billing, metering and payment management through a centralized bill and payment capability, as compared to other approaches such as those that do not employ a central resource.

As described herein, the central resource 218 can change the plurality of services the user device 212 has access to in response to the computing device 200 detecting a change in the monitored characteristic of the user device 212, such as a change in the user device's 212 location. For example, the user device 212 can include a location detection module, which can track the location of the user device 212 in real-time. Tracking the location of the user device 212 in real-time can allow the central resource 218 to determine which services a user should have access to. For example, the computing device 200 can detect the user device 212 has changed locations, communicate the change in location to a central resource, and the central resource can migrate or leverage services across a plurality of cloud service providers in such a way as to minimize the disruption to the user device 212.

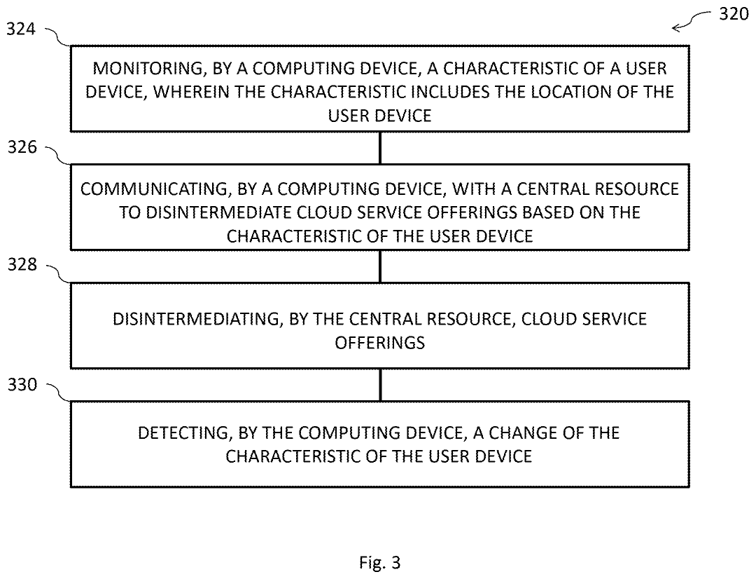

FIG. 3 illustrates an example of a method 320 of cloud service disintermediation consistent with the present disclosure. In some examples, the method 320 can be performed by a computing device, a user device, a central resource, or combinations thereof.

As described herein, at 324, the method 320 can include monitoring, by a computing device, a characteristic of a user device. The monitored characteristic can include the location of the user device. Additional characteristics of the user device which the computing device can monitor can include a quality-of-service, connectivity type, user role, device role, or combinations thereof of the user device.

As described herein, the user device 212 can include a computer (e.g., desktop computer, notebook computer, tablet computer, server computer, etc.), a handheld device (e.g., personal digital assistant, smartphone, etc.), an electronic appliance, a gaming console, or any other type of user device.

As described herein, at 326, the method 320 can include communicating, by a computing device, with a central resource to disintermediate cloud service offerings based on the monitored characteristic of the user device. For example, the computing device can communicate with the central resource to provide the central resource with the status of the monitored characteristic of the user device, such as providing the location of the user device to the central resource.

As described herein, at 328, the method 320 can include disintermediating, by the central resource, cloud service offerings. Disintermediating cloud services can include managing resources across a plurality of cloud service providers and communicating across a plurality of cloud data centers. For example, the central resource can scale cloud service offerings and/or instantiate new cloud service offerings. For example, the present disclosure can be designed to support both the instantiation of new service offerings or scaling service offerings based the monitored characteristic of the user device. This includes the ability to dynamically migrate services from data center to data center and/or from service provider to service provider based on the plurality of characteristics of the user device or based on changes in the plurality of characteristics of the user device.

As described herein, at 328, the method 320 can include detecting, by the computing device, a change in the monitored characteristic of the user device. Additionally, the computing device can communicate with the central resource to disintermediate cloud service offerings based on the detected change of the monitored characteristic of the user device. For example, the central resource can instantiate new cloud services as a result of the computing device alerting the central resource that there has been a change in the monitored characteristic of the user device, such as the user device has changed device role, quality-of-service, connectivity type, and/or user role.

As described herein, the central resource can change the plurality of services the user device has access to in response to the computing device detecting a change in the monitored characteristic of the user device, such as a change in the user device's location. The user device can include a location detection module, which can track the location of the user device in real-time. Tracking the location of the user device in real-time can allow the central resource to determine which services a user should have access to. For example, the computing device can detect the user device has changed locations, communicate the change in location to a central resource, and the central resource can migrate or leverage services across a plurality of cloud service providers in such a way as to minimize the disruption to the user device.

For example, the central resource can include instructions and hardware to disintermediate cloud services. For example, the user device can be using the central resource such as a virtual hosted desktop containing application and files within a cloud service provider. This service is can be hosted within a facility that is in close proximity to the user device. However, if the user device changes location, such as to a different region, the virtualized desktop solution can be migrated to another hosting data center within the cloud service provider. The virtualized desktop solution can also be migrated to a different cloud service provider in order to provide a better quality of service, reduced latency, or reduced costs.

In the foregoing detailed description of the disclosure, reference is made to the accompanying drawings that form a part hereof, and in which is shown by way of illustration how examples of the disclosure may be practiced. These examples are described in sufficient detail to allow those of ordinary skill in the art to practice the examples of this disclosure, and it is to be understood that other examples may be utilized and that process, electrical, and/or structural changes may be made without departing from the scope of the present disclosure.

The figures herein follow a numbering convention in which the first digit corresponds to the drawing figure number and the remaining digits identify an element or component in the drawing. Elements shown in the various figures herein may be capable of being added, exchanged, and/or eliminated so as to provide a number of additional examples of the disclosure. In addition, the proportion and the relative scale of the elements provided in the figures are intended to illustrate the examples of the disclosure, and should not be taken in a limiting sense.

What is claimed:

1. A computing device, comprising:
a processing resource; and
a memory resource storing machine-readable instructions to cause the processing resource to:
monitor a characteristic of a user device, wherein the characteristic includes the location of the user device; and
communicate with a central resource to disintermediate cloud service offerings based on the characteristic of the user device.

2. The computing device of claim 1, wherein the computing device includes a location detection module.

3. The computing device of claim 2, wherein the location detection module tracks the location of the user device in real-time.

4. The computing device of claim 1, wherein the computing device detects a change in the characteristic of the user device.

5. The computing device of claim 4, wherein the computing device communicates with the central resource based on the detection of a change in the characteristic of the user device.

6. The computing device of claim 1, wherein the characteristic of the user device includes a quality-of-service, connectivity type, user role, and/or device role.

7. A system, comprising:
a user device;
a computing device to:
monitor a characteristic of a user device, wherein the characteristic includes the location of the user device; and
communicate with a central resource; and
a central resource to disintermediate cloud service offerings based on the characteristic of the user device.

8. The system of claim 7, wherein the central resource determines a plurality of cloud services the user device has access to based on the characteristic of the user device.

9. The system of claim 7, wherein the central resource manages resources across a plurality of cloud service providers.

10. The system of claim 7, wherein the central resource communicates across a plurality of cloud data centers.

11. The system of claim 7 wherein the central resource consolidates ordering and billing of cloud services across a plurality of cloud services.

12. A method, comprising:
monitoring, by a computing device, a characteristic of a user device, wherein the characteristic includes the location of the user device;
communicating, by a computing device, with a central resource to disintermediate cloud service offerings based on the characteristic of the user device;
disintermediating, by the central resource, cloud service offerings; and
detecting, by the computing device, a change of the characteristic of the user device.

13. The method of claim 12, wherein disintermediating cloud service offerings includes scaling cloud service offerings.

14. The method of claim 12, wherein disintermediating cloud service offerings includes instantiation of new cloud service offerings.

15. The method of claim 12, further comprising:
communicating, by the computing device, with the central resource to disintermediate cloud service offerings based on the change of the characteristic of the user device.
